(19) United States
(12) Patent Application Publication
(10) Pub. No.: US 2008/0229418 A1
(43) Pub. Date: Sep. 18, 2008

(54) System and Method to Customize a Security Log Analyzer

(75) Inventors: Lee Chen, Saratoga, CA (US); John Chiong, San Jose, CA (US); Dennis I. Oshiba, Fremont, CA (US)

Correspondence Address: KAPLAN GILMAN GIBSON & DERNIER L.L.P., 900 ROUTE 9 NORTH, WOODBRIDGE, NJ, 07095, US

(73) Assignee: A10 NETWORKS INC., San Jose, CA (US)

(21) Appl. No.: 11/686,119

(22) Filed: Mar. 14, 2007

(51) Int. Cl. G06F 12/14

(52) U.S. Cl. 726/23

(57) ABSTRACT

Systems and methods adapted to customize a security log analyzer to recognize a security log, the system including at least one network security device for processing data traffic on a data network, the network security device associated with at least one computing device, and adapted to generate a security log, the system further including rule builder software adapted to generate a rule for recognizing at least one item in a security log and a log analyzer adapted to apply the rule in analyzing a security log.

### FIELD OF THE INVENTION

This invention relates generally to data networking, more specifically, to a system and method to customize a security log analyzer to recognize a security log.

### BACKGROUND

A secure data network is a critical component in today's businesses, providing reliable operations and safeguarding their vitality.

In a typical company, users of different business divisions, located at different offices, undertake different business activities over a single company data network. The company typically deploys multiple security appliances such as firewalls and VPN gateways to protect the secure data network and to monitor network usage. These security appliances provide many security functions, from controlling internal and external network access and preventing network intrusion, to monitoring network usage.

Security appliances from different equipment manufacturers report security logs encoded in different log formats, such as WELF, PIX format, or LEA format. Oftentimes, security logs from security appliances of the same equipment manufacturer may have different log formats due to different products, different software releases or the like. Security logs are typically processed in a timely fashion by a log analyzer.

However, deployment and upgrade of security appliances are commonplace due to rapid network growth, technology changes, and new network security threats. As a result, the log analyzer inevitably and frequently encounters a new or changed log format that it does not understand or recognize. The log analyzer either ignores or processes only partially the security logs having a new format. In order to process properly the new formatted security logs, the log analyzer needs to be upgraded or replaced. In the meantime, potential security threats to the data network are overlooked.

Based on the foregoing, there is a need for a solution to customize a security log analyzer to recognize a new security log.

### SUMMARY OF THE INVENTION

In accordance with one aspect the present invention provides a system adapted to customize a security log analyzer to recognize a security log, the system including at least one network security device for processing data traffic on a data network, the network security device associated with at least one computing device, and adapted to generate a security log, the system further including rule builder software adapted to generate a rule for recognizing at least one item in a security log and a log analyzer adapted to apply the rule in analyzing a security log.

In accordance with another embodiment, the invention includes a method of customizing a security log analyzer to recognize a security log, including generating at least one rule for recognizing at least one item in the security log and associating the rule with the log analyzer. In one embodiment the method employs a log analyzer associated with a system including at least one network security device adapted to process data traffic on a data network, the network security device associated with at least one computing device and adapted to generate a security log, the system further including a means for generating at least one rule for recognizing at least one item in a security log, and the security log analyzer is adapted to apply the at least one rule in analyzing a security log.

In accordance with yet another embodiment, a method is provided for recognizing at least one log item in a security log including generating a rule for recognizing at least one log item in a security log and processing the log item in a security log analyzer to recognize a security element based on the rule.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1a is a block diagram of a system in accordance with at least one aspect of the present invention.

FIG. 1b is a graphical representation of examples of a security element in accordance with one aspect of the present invention.

FIG. 1c is a schematic representation of the functional relationship between elements in accordance with one aspect of the present invention.

FIG. 2 is a schematic representation of an embodiment of a system in accordance with one aspect of the present invention.

FIG. 3 is a schematic representation of an embodiment of a system in accordance with one aspect of the present invention.

### DETAILED DESCRIPTION OF THE PREFERRED EMBODIMENTS

In the following description, for the purposes of explanation, specific numbers, materials and configurations are set forth in order to provide a thorough understanding of the invention. It will be apparent, however, to a person of ordinary skill in the art, that these specific details are merely exemplary embodiments of the invention. In some instances, well known features may be omitted or simplified so as not to obscure the present invention. Furthermore, reference in the specification to “one embodiment” or “an embodiment” is not meant to limit the scope of the invention, but instead merely provides an example of a particular feature, structure or characteristic of the invention described in connection with the embodiment. Insofar as various embodiments are described herein, the appearances of the phase “in an embodiment” in various places in the specification are not meant to refer to a single or same embodiment.

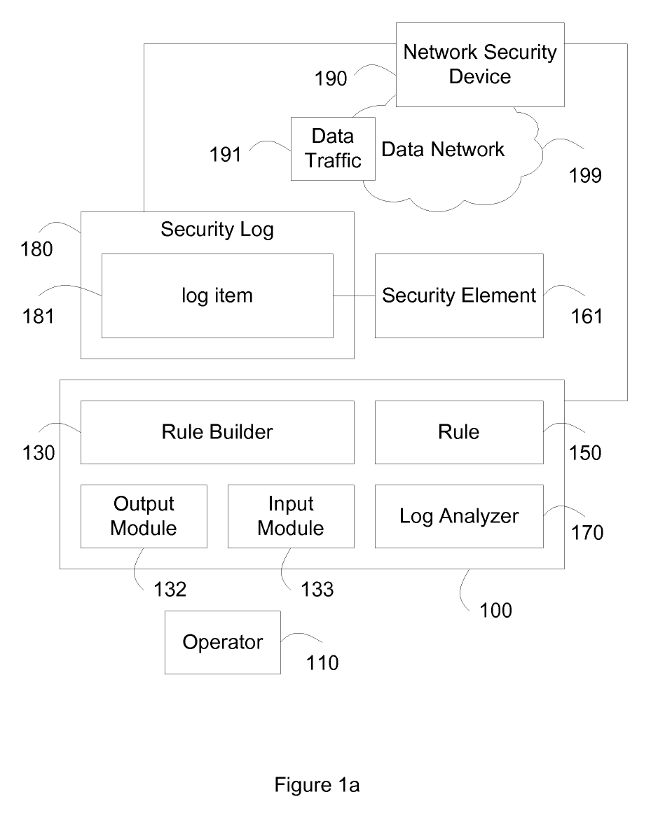

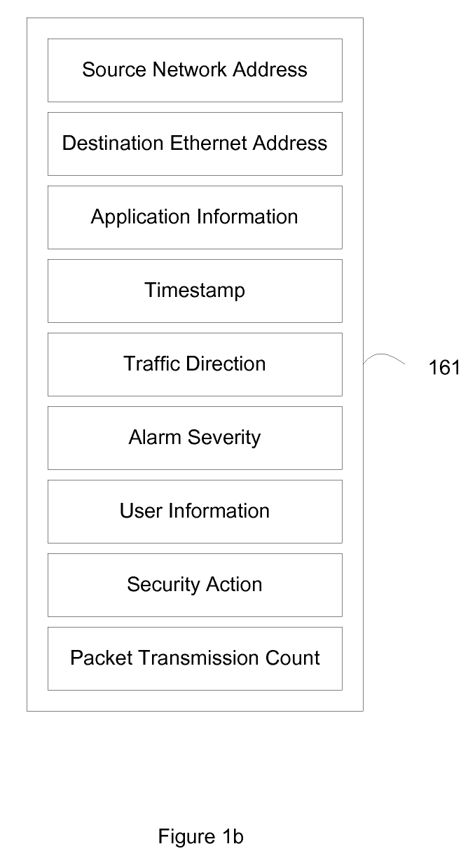

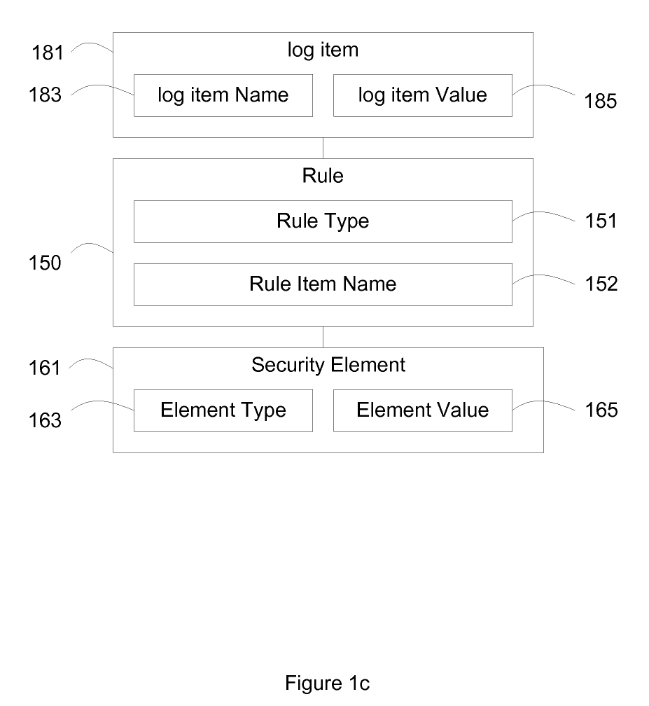

With reference to the drawings, wherein like numerals indicate like elements, there is shown in FIG. 1 in accordance with at least one embodiment, a simplified block diagram depicting at least one network security device 190 for processing data traffic 191 on data network 199, the network security device 190 associated with at least one computing device 100, and adapted to generate a security log 180.

Data network 199 is preferably based on Internet Protocol (IP). Data network 199 may include a network such as but not limited to a wide area network (WAN) such as the Internet, Ethernet, a wireless local area network (WLAN), corporate data network, service provider data network, or virtual private network (VPN).

Network security device 190 may include a device such as but not limited to an Ethernet switch, a router, a border gateway, a broadband gateway, a firewall, a wireless access point, a security appliance, or an application gateway. In one embodiment, network security device 190 is an identity management server or authentication server that handles secure identity information. In another embodiment, network security device 190 is a document server that handles secure documents such as bank accounts, financial records, corporate confidential documents, medical records or the like.

Network security device 190 is adapted to detect computer viruses, network intrusion or malicious attack in data traffic 191, such as but not limited to spyware, adware, or the like. Network security device 190 may be adapted to enforce security policies such as but not limited to user identity management policy, document access policy, website access policy, peer-to-peer traffic policy, application access policy or the like. Enforcement of security policy may include recording, duplicating, redirecting, or blocking of data traffic 191. Examples of security software or protocols that perform this functionality include security software based on Network Access Control (NAC) technologies, Zero-day Threat Prevention, anti-virus and stateful packet inspection technologies available from companies such as Cisco Systems, 3COM and Juniper Networks.

As is well known to those having skill in the art, network security device 190 generates a security log 180 to report a security event about data traffic 191. For example, network security device 190 may send security log 180 using syslog protocol described in IETF RFC 3164 “The BSD Syslog Protocol”, the entirety of which is incorporated by reference herein. Network security device 190 may store security log 180 in a log file and/or send security log 180 in an email. Security log 180 includes at least one log item 181. Log item 181 includes a security element 161. Now referring further to FIG. 1b, examples of security elements 161 are shown. By way of example, security element 161 may include a source IP address, a destination Ethernet address, information about an application such as but not limited to a destination TCP port number, a timestamp, direction of data traffic 191, user information such as a user name or an employee number, a security severity, or a security policy, such as the blocking of data traffic 191.

In one embodiment, log item 181 is a character string. Now referring further to FIG. 1c, log item 181 may include log item name 183 and log item value 185. Log item name 183 can be employed to identify security element 161. Log item value 185 is the value of security element 161. The log item value 185 becomes the security element value 165 through the application of a rule 150. In other words, for example, an operator assigns the rule 150 that log item value 185=security element value 165. In one example, log item 181 is “src_address=192.168.1.102”. Log item name 183 is “src_address=”, identifying security element 161 as the source IP address. Log item value 185 is IP address “192.168.1.102”. In another example, log item 181 is “alarm:red”. Log item name 183 is “alarm:”, identifying security element 161 as security severity. Log item value 185 is security severity “red”.

In one embodiment, the position of log item 181 in security log 180 identifies security element 161. In one example, log item 181 “Oct. 22, 2006/10:30 pm” is the fifth log item in security log 180. The fifth position identifies security element 161 as a timestamp and “Oct. 22, 2006/10:30 pm” is the value of the timestamp.

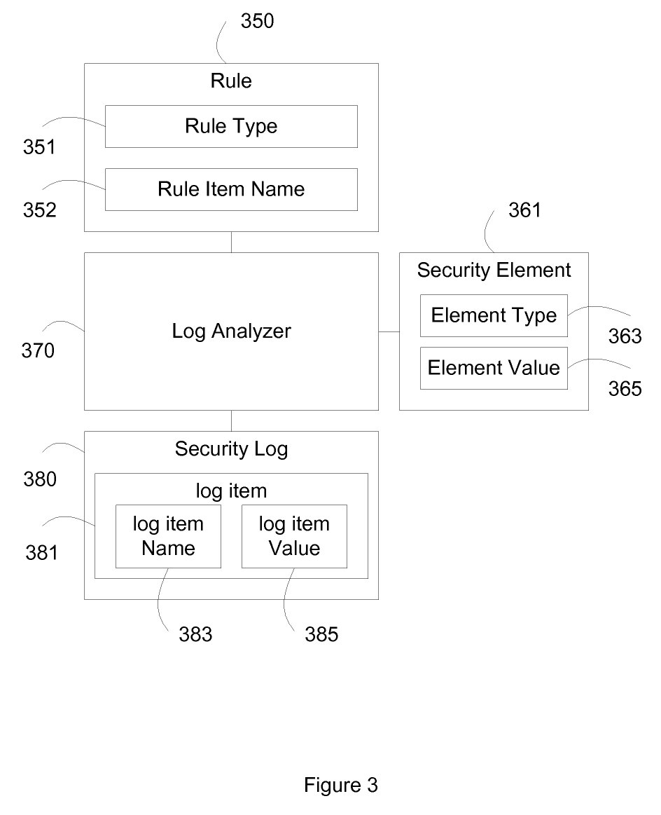

Rule 150 is generated by the operator using rule builder 130 and includes syntactic and/or semantic information to process log item 181 to recognize security element 161. Security element 161 includes element type 163 and element value 165. As is described in further detail hereinbelow with respect to FIG. 3, log analyzer 170 applies the rule 150 to recognize a security element 161 in a log item 181 based on the rule 150. Element type 163 and element value 165 are based on log item 181 using rule 150.

In one embodiment, rule 150 includes rule type 151, and rule item name 152. In an embodiment the rule type 151 and rule item name 152 are decided upon and input by the operator, as discussed in further detail hereinbelow. Rule type 151 indicates the type of security element 161, such as source IP address, timestamp or the like. Rule item name 152 includes information for the recognition of security element 161. For example, rule item name 152 may include a character string such as “src_addr=”; or indicate a position such as the fifth position.

In accordance with at least one embodiment, rule 150 matches log item 181 when rule item name 152 matches log item name 183. Upon matching rule 150 to log item 181, element type 163 would be set to rule type 151 and element value 165 would be set to log item value 185.

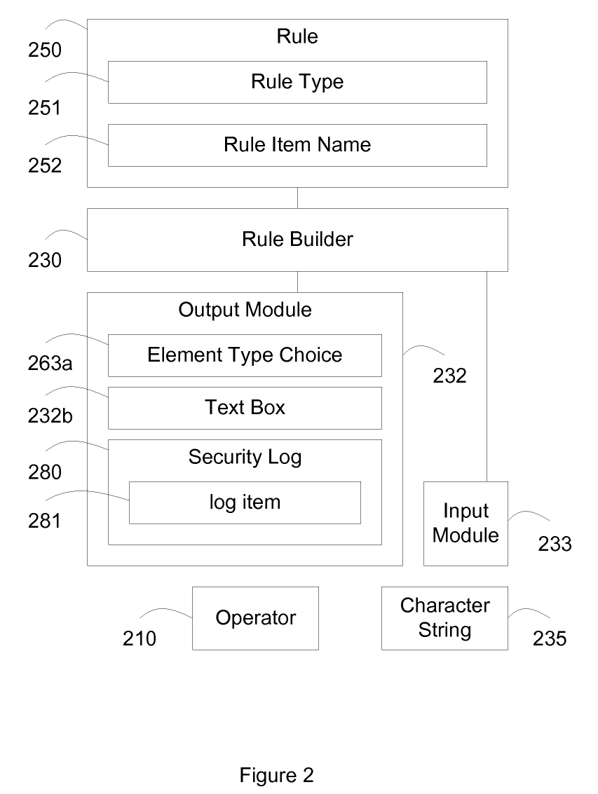

Rule builder 130 is a software application running on a computing device 100. Rule builder 130 generates rule 150 through interaction with operator 110. Rule builder 130 interacts with operator 110 via output module 132 and input module 133 of the computing device 100. Output module 132 includes a display screen. In one embodiment, input module 133 includes a mouse, a keyboard, a stylus, a touchscreen or a pointing device. A process for rule builder 130 to generate rule 150 is described in further detail hereinbelow with reference to FIG. 2.

Log analyzer 170 is a software application running on a computing device 100. Log analyzer 170 processes log item 181 in security log 180 to recognize security element 161 based on rule 150. Log analyzer 170 obtains security log 180 from network security device 190, such as but not limited to via syslog protocol, from a log file, or via an email. A process for log analyzer 170 to recognize security element 161 is described in further detail hereinbelow with reference to FIG. 3.

Now referring to FIG. 2, in accordance with at least one embodiment a method of generating a rule is illustrated. Operator 210 interacts with rule builder 230 via output module 232 and input module 233 to generate rule 250. Rule 250 includes rule type 251 and rule item name 252. As an example, rule 150 is encoded in text format, such as “src_addr=$Source_IP Address$”.

In one embodiment, rule builder 230 displays a list of security element type choices that includes element choice 263a at output module 232. Element type choices include common element types known to those having skill in the art. Operator 210 uses input module 233 to select element choice 263a. Rule builder 230 sets rule type 251 to element type choice 263a based on operator input. In one embodiment, rule builder 230 displays text box 232b on a GUI associated with computing device 100, prompting operator 210 to enter a character string 235 using input module 233. For example, character string 235 may be “time=”, “dest_addr:” or the like. Rule builder 230, based on input choice of the operator 210, sets rule item name 252 to character string 235. Rule builder 230 generates rule 250 using rule type 251 and rule item name 252.

In one embodiment, rule builder 230 displays security log 280 at output module 232 and automatically highlights log item 281. Operator 210 interacts with rule builder 230 to generate rule 250 for the highlighted log item 281 in a similar fashion.

FIG. 3 illustrates a system including a log analyzer 370 in accordance with the present invention adapted to recognize a security element 361 in a log item 381 based on a rule 350.

In accordance with one embodiment, log analyzer 370 includes rule 350. Log analyzer 370 processes log item 381 in security log 380 to recognize security element 361 based on rule 350. Rule 350 includes rule type 351 and rule item name 352. Log item 381 includes log item name 383 and log item value 385. Security element 361 includes element type 363 and element value 365.

Log analyzer 370 matches rule 350 against log item 381. Log analyzer 370 determines whether rule item name 352 matches log item name 383. For example, log analyzer 370 may determine that rule item name 352 matches a character string starting at the first character of log item 381. For example, rule item name 352 may be “dest_address=”, while log item 381 is identified as “dest_address=192.168.1.102”. In this instance, log analyzer 370 determines that rule item name 352 “dest_address=” matches “dest_address=” in log item 381. In the case where a match is established log analyzer 370 sets element type 363 to rule type 351.

In one embodiment log analyzer 370 may also extract a log item value 385 based on the remaining character string after log item name 383 in log item 381. For example, log analyzer 370 may extract the log item value 385 “192.168.1.102” from log item 381 “dest_addr=192.168.1.102”. Log analyzer 370 sets element value 365 to log item value 385. In another example, rule item name 352 may indicate a position. Log analyzer 370 may determine if log item 381 is in the corresponding position in security log 380, as specified by rule item name 352.

Security log 380 may include a plurality of log items 381. In accordance with one embodiment, log analyzer 370 processes the plurality of log items 381 to recognize a plurality of security elements 361. Log analyzer 370 may further include a plurality of rules 350. In one embodiment, log analyzer 370 may analyze security log 380 in conjunction with other security logs 370.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A system adapted to customize a security log analyzer to recognize a security log, the system comprising at least one network security device adapted to process data traffic on a data network, the network security device associated with at least one computing device and adapted to generate a security log, the system further including a means for generating at least one rule for recognizing at least one log item in a security log and a log analyzer adapted to apply the at least one rule in analyzing a security log.

2. The system in accordance with claim 1, the means for generating at least one rule comprising rule builder software.

3. The system in accordance with claim 1, the rule comprising a rule type and rule item name.

4. The system in accordance with claim 3 wherein the rule type indicates the type of security element selected from at least one of a source IP address or a timestamp.

5. The system in accordance with claim 3 wherein the rule item name comprises information for the recognition of a security element.

6. The system in accordance with claim 2 wherein the rule builder software is associated with the computing device, the computing device further comprising an input module and an output module.

7. The system in accordance with claim 6, the rule builder software adapted to display information to an operator via the output module and receive information from the operator via the input module to generate the rule comprising a rule type and a rule item name.

8. The system in accordance with claim 7 wherein the rule builder software is adapted to display a plurality of security element type choices at the output module.

9. The system in accordance with claim 8 wherein the rule builder is adapted to set the rule type to the security element type choice based on operator input.

10. The system in accordance with claim 1, the log analyzer comprising software running on the computing device, the software adapted to process at least one log item in a security log to recognize a security element based on the rule.

11. The system in accordance with claim 1 wherein the log analyzer comprises at least one rule.

12. A method of customizing a security log analyzer to recognize a security log, comprising generating at least one rule for recognizing at least one item in the security log and associating the rule with the log analyzer.

13. The method in accordance with claim 12 wherein the security log analyzer is associated with a system comprising at least one network security device adapted to process data traffic on a data network, the network security device associated with at least one computing device and adapted to generate a security log, the system further including a means for generating at least one rule for recognizing at least one item in a security log, and the security log analyzer is adapted to apply the at least one rule in analyzing a security log.

14. The method in accordance with claim 12, the method comprising providing, in a computing device associated with a network security device, rule builder software adapted to create the rule comprising at least a rule type and rule item name.

15. The system in accordance with claim 14 wherein the rule type indicates the type of security element selected from at least one of a source IP address or a timestamp.

16. The system in accordance with claim 14 wherein the rule item name comprises information for the recognition of a security element.

17. A method for recognizing at least one log item in a security log comprising generating a rule for recognizing at least one log item in a security log and processing the log item in a security log analyzer to recognize a security element based on the rule.

18. The method in accordance with claim 17 wherein the security log analyzer is associated with a system comprising at least one network security device adapted to process data traffic on a data network, the network security device associated with at least one computing device and adapted to generate a security log, the system further including a means for generating at least one rule for recognizing at least one log item in a security log.

19. The method in accordance with claim 17, the method comprising providing, in a computing device associated with a network security device, rule builder software adapted to create a rule comprising at least a rule type and a rule item name.

20. The system in accordance with claim 19 wherein the rule type indicates the type of security element selected from at least one of a source IP address or a timestamp.

21. The system in accordance with claim 19 wherein the rule item name comprises information for the recognition of a security element.
